(19) United States
(12) Patent Application Publication
(10) Pub. No.: US 2026/0010315 A1
(43) Pub. Date: Jan. 8, 2026

(54) WRITE ACCUMULATION TRIGGERED BLOCK ERASE IN A DATA STORAGE DEVICE

(71) Applicant: Sandisk Technologies, Inc., Milpitas, CA (US)

(72) Inventors: Ramanathan Muthiah, Bangalore (IN); Roshini Hegde, Bangalore (IN)

(21) Appl. No.: 18/761,695

(22) Filed: Jul. 2, 2024

(51) Int. Cl. G06F 3/06

(52) U.S. Cl. CPC G06F 3/0659; G06F 3/061; G06F 3/0652; G06F 3/0679

(57) ABSTRACT

A data storage device includes a scheduling system that monitors a number of commands in a command queue and determines which of the commands in the command queue are write commands. The scheduling system also determines a sum of a size of the write commands in the command queue and compares it to an amount of available space in a currently operating metablock. If the sum of the size of the write commands exceeds the available amount of space in the currently operating metablock, the scheduling system identifies a target metablock and proactively initiates an erase operation on the target metablock prior to the currently operating metablock reaching capacity.

### BACKGROUND

Data storage devices, such as NAND data storage devices, typically arrange or organize memory blocks into metablocks. During write operations, a metablock on which data is being written is completely filled prior to accessing another metablock. For example, when the current metablock has reached capacity, the current metablock is closed and a new metablock is opened for writing. However, before the new metablock can be written to, it is typically erased.

The process of closing the current metablock and opening a new metablock for further writing is referred to as a block exchange. However, whenever a block exchange occurs, the data storage device experiences a performance drop. For example, during an erase operation, the memory dies associated with the new metablock cannot execute other operations (e.g., write operations).

In some instances, the amount of time it takes to erase a memory block is five milliseconds or more. While this delay can negatively impact the performance of the data storage device, pre-erasing a memory block (e.g., during idle time) and holding the memory block open until it is needed, negatively impacts data endurance when that memory block is ultimately used.

Accordingly, it would be beneficial for a data storage device to address latency issues associated with a block exchange process while also avoiding memory block endurance issues that will arise by pre-erasing a memory block.

### SUMMARY

The present disclosure describes a scheduling system for a data storage device. In an example, the scheduling system is operable to proactively erase one or more memory blocks associated with a target metablock when a sum of a size of data of upcoming or scheduled write commands exceeds an amount of available free space in a metablock on which current write operations are being executed.

For example, the scheduling system analyzes various commands in a command queue and determines which of the commands in the command queue are write commands. The scheduling system also determines a sum of the size of the write commands in the command queue. The sum of the size of the write commands in the command queue is a total amount of data that will be written to one or more metablocks should all of the write commands in the command queue be executed. For example, if the scheduling system identifies two write commands in the command queue, and each write command is associated with 4 kilobytes (KB) of data, the sum of the size of the write commands is 8 KB.

Based on determining the sum of the size of the write commands, the scheduling system compares the sum of the size of the write commands to an amount of available space in the metablock to which write commands are currently being executed (referred to herein as the “currently operating metablock”). If the sum of the size of the write commands exceeds the available amount of space in the currently operating metablock, the scheduling system identifies and proactively initiates an erase operation on a target metablock prior to the currently operating metablock reaching capacity.

In an example, memory dies associated with the currently operating metablock are the same as the memory dies associated with the target metablock. In such an example, the erase operations performed on the target metablock occur concurrently with the write operations being executed on the currently operating metablock. For example, as write operations are ongoing on the current metablock, the memory dies are free in between different write operations. As such, erase operations (e.g., stepwise erase operations) are initiated on the target metablock during that free time.

In another example, memory dies associated with the currently operating metablock are different from the memory dies associated with the target metablock. As a result, the erase operations on the target metablock occur in parallel with the write operations that are executed on the currently operating metablock.

As such, the latency associated with block exchange is substantially reduced or eliminated. In an example, and based on the number, size and/or type of commands in the command queue, the scheduling system determines that the target metablock will be used within a threshold amount of time. As a result, any memory block endurance concerns are addressed because the erased memory blocks of the target metablock will not be held in an erased state for an undetermined amount of time.

Accordingly, examples of the present disclosure describe a method that includes identifying one or more write commands that are to be executed on a currently operating metablock of a data storage device and determining a size associated with each of the one or more write commands. The method also includes determining an amount of available space in the currently operating metablock. The method also includes comparing the amount of available space in the currently operating metablock with a sum of the determined size associated with each of the one or more write commands. An erase operation is initiated on a target metablock based, at least in part, on determining the sum of the determined size associated with each of the one or more write commands is greater than the amount of available space in the currently operating metablock. In an example, the erase operation is initiated prior to the currently operating metablock reaching capacity.

Additional examples describe a data storage device having a controller and a scheduling system associated with the controller. In an example, the scheduling system is operable to analyze one or more received commands and identify which of the one or more commands are write commands. The scheduling system is also operable to determine a sum of a size of the write commands, compare an amount of available space in a currently operating metablock with the sum of the size of the write commands and initiate an erase operation on a target metablock. In an example, the erase operations on the target metablock are initiated based, at least in part, on a determination that the sum of the size of the write commands exceeds the amount of available space in the currently operating metablock. In an example, the erase operation is initiated prior to the currently operating metablock reaching capacity.

Still other examples describe a data storage device that includes means for identifying one or more write commands that are to be executed on a currently operating metablock of a data storage device. The data storage device also includes means for determining a size associated with each of the one or more write commands and means for determining an amount of available space in the currently operating metablock. In an example, the data storage device also includes means for comparing the amount of available space in the currently operating metablock with a sum of the determined size associated with each of the one or more write commands and means initiating an erase operation on a target metablock. In an example, the erase operation is initiated based, at least in part, on a determination that the sum of the determined size associated with each of the one or more write commands is greater than the amount of available space in the currently operating metablock. In an example, the erase operation is initiated while one or more write commands are being executed on the currently operating metablock.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2A illustrates how a memory device includes a number of memory blocks according to an example.

FIG. 2B illustrates how a memory block includes one or more pages according to an example.

FIG. 2C illustrates how a memory block includes a number of bit lines and wordlines according to an example.

FIG. 3A illustrates a command queue according to an example.

FIG. 3B illustrates a currently operating metablock according to an example.

FIG. 4A illustrates the command queue of FIG. 3A in which another write command has been received according to an example.

FIG. 4B illustrates how a target metablock is proactively erased in response to a scheduling system determining a sum of a size of write commands in the command queue of FIG. 4A exceeds a capacity of a currently operating metablock according to an example.

FIG. 5A illustrates the command queue of FIG. 3A in which some commands have been executed and additional commands have been received according to an example.

FIG. 5B illustrates how a target metablock is proactively erased in response to a scheduling system determining a sum of a size of write commands in the command queue of FIG. 5A exceeds a capacity of a currently operating metablock according to an example.

FIG. 6 illustrates a method for proactively erasing memory blocks of a target metablock according to an example.

FIG. 7 is a perspective view of a storage device that includes three-dimensional (3D) stacked non-volatile memory according to an example.

FIG. 8 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Block exchange is a process in which a data storage device, such as NAND data storage device, erases memory blocks of a target metablock only when a metablock on which operations are currently being executed has reached capacity and/or is closed. For example, when the current metablock has reached capacity, the current metablock is closed and a new metablock is opened for writing. To open the new metablock, memory blocks associated with the new metablock are erased.

In some instances, the amount of time it takes to erase a memory block is five milliseconds or more. Additionally, during execution of the erase operations, the memory dies associated with the new metablock are busy erasing data from the memory blocks. As such, data cannot be written to those memory dies at the same time. This delay can negatively impact performance of the data storage device. Typically, this delay cannot be overcome by pre-erasing a memory block and holding it open until it is needed as holding open a memory block negatively impacts data endurance when that memory block is ultimately used.

To address the above, the present disclosure describes a data storage device having a scheduling system that proactively erases one or more memory blocks associated with a target metablock when a sum of a size of data of upcoming or scheduled write commands will exceed an available amount of space remaining in a metablock on which current write operations are being executed (referred to herein as a “currently operating metablock”).

As will be described in greater detail herein, the scheduling system analyzes various commands that will be executed by a controller of the data storage device and determines which of the commands are write commands. The scheduling system also determines a sum of the size of the write commands in the command queue. In an example, the sum of the size of the write commands in the command queue is a total amount of data that will be written to one or more metablocks of a data storage device should all of the write commands in the command queue be executed. For example, if the scheduling system identifies two write commands in the command queue, and each write command is associated with four kilobytes (KB) of data, the sum of the size of the write commands is eight KB. In an example at least one of the write commands is a sequential write command. In another example, at least one of the write commands is a random write command.

Although a command queue is specifically mentioned, the various operations described herein can be executed on any commands that are received and that are placed in any type of queue for execution. For example, during a garbage collection process, an internal queue (e.g., a firmware queue) includes various commands that specify the amount of data that is to be written to a currently operating garbage collection destination metablock.

The scheduling system compares the sum of the size of the write commands to an available amount of space in the currently operating metablock. If the sum of the size of the write commands exceeds the available amount of space in the currently operating metablock, the scheduling system identifies and/or initiates an erase operation on a target metablock prior to the currently operating metablock reaching capacity.

In an example, memory dies associated with the currently operating metablock are the same as the memory dies associated with the target metablock. In such an example, the erase operations associated with the target metablock occur concurrently with the write operations being executed on the currently operating metablock. For example, as write operations are being executed on the currently operating metablock, the memory dies are free in between different write operations. As such, erase operations (e.g., stepwise erase operations) are initiated on the target metablock between the write operations.

In another example, memory dies associated with the currently operating metablock are different from the memory dies associated with the target metablock. As a result, the erase operations on the memory dies associated with the target metablock occur in parallel with the write operations being executed on the currently operating metablock.

Accordingly, many technical benefits may be realized including, but not limited to, reducing or eliminating the latency associated with block exchange, which improves the overall performance of the data storage device and reducing or eliminating memory block endurance concerns because the proactively erased memory blocks will be used within a predetermined amount of time from being erased.

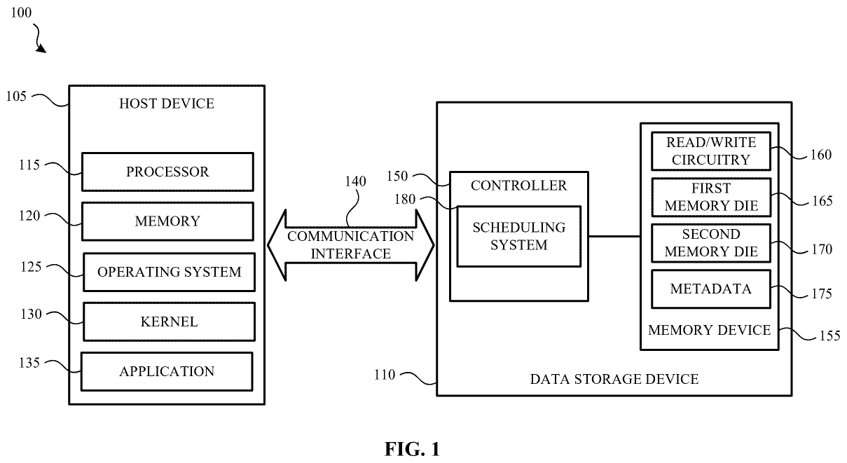

These benefits, along with other examples, will be shown and described in greater detail with respect to FIG. 1-FIG. 8.

FIG. 1 is a block diagram of a system 100 that includes a host device 105 and a data storage device 110 according to an example. In an example, the host device 105 includes a processor 115 and a memory 120 (e.g., main memory). The memory 120 includes or is otherwise associated with an operating system 125, a kernel 130 and/or an application 135.

The processor 115 can execute various instructions, such as, for example, instructions from the operating system 125 and/or the application 135. The processor 115 includes circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 includes a System on a Chip (SoC).

In an example, the memory 120 is used by the host device 105 to store data used, or otherwise executed by, the processor 115. Data stored in the memory 120 includes instructions provided by the data storage device 110 via a communication interface 140. The data stored in the memory 120 also includes data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 creates a virtual address space for the application 135 and/or other processes executed by the processor 115. The virtual address space maps to locations in the memory 120. The operating system 125 also includes or is otherwise associated with a kernel 130. The kernel 130 includes instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

The data storage device 110 includes a controller 150 and a memory device 155. In an example, the controller 150 is communicatively coupled to the memory device 155. The memory device 155 includes one or more memory dies (e.g., a first memory die 165 and a second memory die 170). Although memory dies are specifically mentioned, the memory device 155 may include any non-volatile memory device, storage device, storage elements or storage medium including NAND flash memory cells and/or NOR flash memory cells.

The memory cells can take the form of solid-state (e.g., flash) memory cells and can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. In one example, the memory cells are arranged in a two-dimensional configuration. In another example, the memory cells are arranged in a three-dimensional configuration.

In an example, the data storage device 110 is attached to or embedded within the host device 105. In another example, the data storage device 110 is implemented as an external device or a portable device that can be communicatively or selectively coupled to, and removed from, the host device 105. In yet another example, the data storage device 110 is a component (e.g., a solid-state drive (SSD)) of a network accessible data storage system, a network-attached storage system, a cloud data storage system, or the like.

As indicated above, the memory device 155 of the data storage device 110 includes a first memory die 165 and a second memory die 170. Although two memory dies are shown, the memory device 155 may include any number of memory dies (e.g., one memory die, two memory dies, eight memory dies, or another number of memory dies).

The memory device 155 also includes support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

In an example, one or more of the first memory die 165 and the second memory die 170 include one or more memory blocks. In an example, each memory block includes one or more memory cells. A block of memory cells is the smallest number of memory cells that are physically erasable together. In an example and for increased parallelism, each of the blocks may be operated or organized in larger blocks or metablocks. For example, one block from different memory dies may be logically linked together to form a metablock.

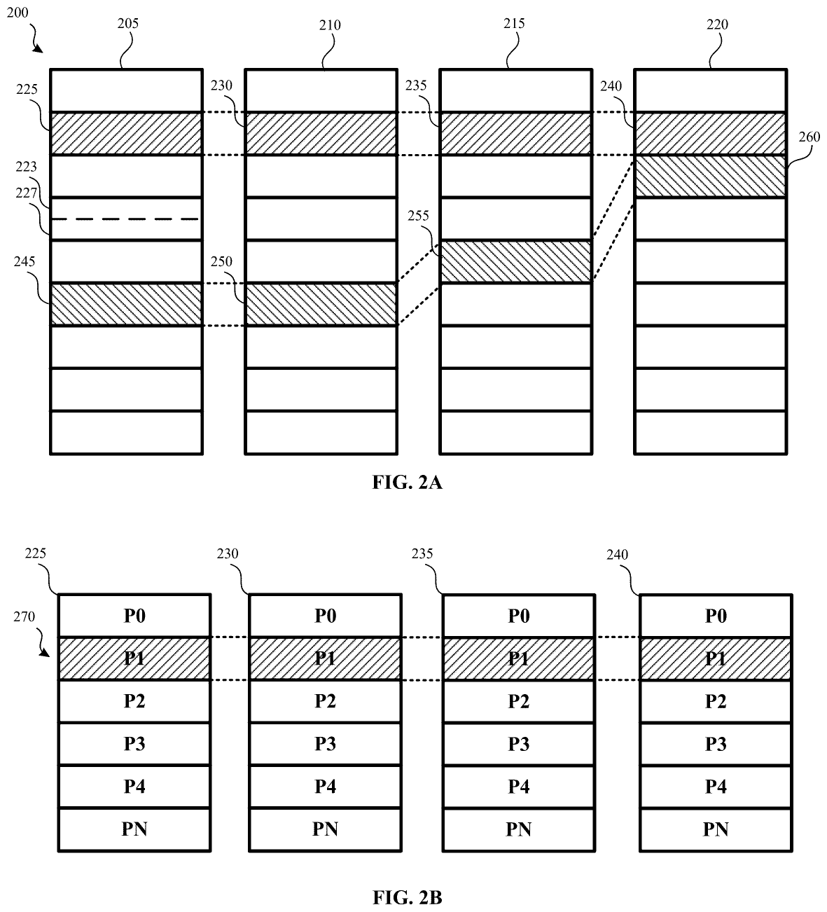

FIG. 2A illustrates how a memory device 200 includes a number of memory blocks according to an example. In this example, the memory device 200 (e.g., a storage element, a memory die, a non-volatile memory device) includes four planes or sub-arrays (e.g., a first plane 205, a second plane 210, a third plane 215, and a fourth plane 220). In an example, the planes are integrated on a single memory die. In another example, the planes are provided on two different memory dies (e.g., two planes on each memory die). In yet another example, the planes are provided on four separate memory dies. Although four planes are shown and described, the memory device 200 may have any number of planes and/or memory dies.

In an example, each plane is divided into memory blocks consisting of memory cells. As shown in FIG. 2A, the rectangles represent a memory block, such as memory block 225, memory block 230, memory block 235 and memory block 240. There may any number of memory blocks in each plane of the memory device 200. In an example, each memory block is a unit of erase and is sometimes referred to as an erase block. For example, memory block 225, memory block 230, memory block 235 and memory block 240 include a minimum number of memory cells that are erased together.

In an example, a memory block can be divided into sub-blocks. For example, a memory block can be divided into a first sub-block 223 and a second sub-block 227. In such an example, each sub-block will be associated with various physical wordlines and/or logical wordlines.

For example, if the memory block has 216 wordlines, the first sub-block 223 will be comprised of physical wordlines 0-107 while the second sub-block 227 will be comprised of physical wordlines 108-215. The first sub-block 223 and the second sub-block 227 are also associated with logical wordlines.

For example, the first sub-block 223 and the second sub-block 227 will each be associated with logical wordline 0 through logical wordline 107. However, in an example, the numbering of the wordlines decreases from top to bottom in the first sub-block and increases from top to bottom in the second sub-block. For example, physical wordline 0 in the memory block corresponds to logical wordline 107 in the first sub-block 223 and physical wordline 107 in the memory block corresponds to logical wordline 0 in the first sub-block 223.

The same is true for the second sub-block 227 in the memory block. For example, physical wordline 108 in the memory block corresponds to logical wordline 0 in the second sub-block 227 and physical wordline 215 in the memory block corresponds to logical wordlines 107 in the second sub-block 227. Although specific physical wordline numbers and logical wordline numbers are given, these are for example purposes only.

In an example, various memory blocks are logically linked or grouped together (e.g., using a table in or otherwise accessible by the controller 150 (FIG. 1)) to form a metablock. A metablock is written to, read from and/or erased as a single unit. For example, memory block 225, memory block 230, memory block 235 and memory block 240 form a first metablock while memory block 245, memory block 250, memory block 255 and memory block 260 form a second metablock. The memory blocks used to form a metablock need not be restricted to the same relative locations within their respective planes.

In examples in which memory blocks are divided into sub-blocks, due to the way in which the logical wordlines of each sub-block are mapped to the physical wordlines of the memory block, a first sub-block of one memory die (or of one plane of one memory die) can be linked to other first sub-blocks of other memory dies (or other planes of the same memory die) when forming a metablock. Likewise, second sub-blocks of one memory die can be linked to other second sub-blocks of other memory dies when forming a metablock.

In an example, each memory block is divided, for operational purposes, into pages of memory cells. For example and referring to FIG. 2B, FIG. 2B illustrates how a memory block includes one or more pages according to an example. For example, the memory cells of memory block 225, memory block 230, memory block 235 and memory block 240 are divided into N different pages (shown as P0-PN). Although a specific number of pages are shown in FIG. 2B, a memory block may have any number of pages of memory cells within each memory block.

In an example, a page is a unit of data programming within the memory block. Each page includes the minimum amount of data that can be programmed at one time. The minimum unit of data that can be read at one time may be less than a page. For example, each page is further dividable into segments or units and each segment includes the fewest number of memory cells that may be written to at one time as a basic programming operation.

A metapage 270 is illustrated in FIG. 2B as being formed of one physical page from each of memory block 225, memory block 230, memory block 235 and memory block 240. In the example, shown, the metapage 270 includes page P1 in each of the four memory blocks. However, the pages of the metapage 270 need not have the same relative position within each of the memory blocks. A metapage 270 may be the maximum unit of programming within a memory block.

The memory blocks disclosed in FIG. 2A-FIG. 2B are referred to herein as physical memory blocks because they relate to groups of physical memory cells as discussed above. As used herein, a logical memory block is a virtual unit of address space defined to have the same size as a physical memory block. Each logical memory block includes a range of logical memory block addresses (LBAs) that are associated with data received from a host. The LBAs are then mapped to one or more physical memory blocks in the data storage device 110 where the data is physically stored.

As indicated above, each memory block includes any number of memory cells. The design, size, and organization of a memory block depends on the architecture, design, and application desired for each memory die. In an example, the memory block includes a contiguous set of memory cells that share a plurality of wordlines and bit lines.

FIG. 2C illustrates how a memory block includes a number of bit lines 275 and wordlines 280 according to an example. For example and as shown in FIG. 2C, the memory block 225 includes bit lines BLO-BLN (collectively bit lines 275), where N is a total number of bit lines. Additionally, the memory block 225 includes wordlines WL0-WLN (collectively wordlines 280), where N is a total number of wordlines. In an example, multiple memory blocks can share the same bit line.

A wordline 280 may function as a single-level-cell (SLC) wordline, a multi-level-cell (MLC) wordline, a tri-level-cell (TLC) wordline, a quad-level cell (QLC) wordline, a penta-level cell (PLC) wordline and so on. Additionally, each memory cell may be programmable to a state (e.g., a threshold voltage in a flash configuration or a resistive state in a resistive memory configuration) that indicates one or more values.

In the example shown in FIG. 2C, four memory cells are connected in series to form a NAND string. Although four memory cells are depicted, any number of memory cells (e.g., 16, 32, 64, 128, 256 or any other number or memory cells) may be used. One terminal of the NAND string is connected to a corresponding bit line via a drain select gate (connected to select gate drain line SGD) and another terminal of the NAND string is connected to a source line via a source select gate (connected to select gate source line SGS). Additionally, although eight bit lines are shown in FIG. 2C, any number of bit lines may be used.

Referring back to FIG. 1, as previously described, the data storage device 110 also includes a controller 150. Although a single controller 150 is shown and described, the data storage device 110 can include multiple controllers. In such an example, a first controller executes a first operation, or set of operations, and the second controller executes a second operation, or set of operations. In an example, the first set of operations and the second set of operations are executed on the same memory dies. In other examples, the first set of operations is executed on a first memory die or a first set of memory dies and the second set of operations is executed on a second memory die or a second set of memory dies.

The controller 150 is communicatively coupled to the memory device 155 via a bus, an interface or other communication circuitry. In an example, the communication circuitry includes one or more channels to enable the controller 150 to communicate with the first memory die 165 and/or the second memory die 170 of the memory device 155. In another example, the communication circuitry includes multiple distinct channels which enables the controller 150 to communicate with the first memory die 165 independently and/or in parallel with the second memory die 170 of the memory device 155.

The controller 150 receives data and/or instructions from the host device 105. The controller 150 also sends data to the host device 105. For example, the controller 150 sends data to and/or receives data from the host device 105 via the communication interface 140. The controller 150 also sends data and/or commands to, and/or receive data from, the memory device 155.

The controller 150 sends data, and a corresponding write command, to the memory device 155 to cause the memory device 155 to store data at a specified address of the memory device 155. In an example, the write command specifies a physical address of a portion of the memory device 155. The controller 150 also sends data and/or commands associated with one or more background scanning operations, garbage collection operations, and/or wear leveling operations.

The controller 150 also sends one or more read commands to the memory device 155. In an example, the one or more read commands specify the physical address of a portion of the memory device 155 at which the data is stored. The controller 150 also tracks the number of program/erase cycles or other programming operations that have been performed on or by the memory device and/or the memory dies of the memory device 155.

The controller 150 also includes, or is otherwise associated with, a scheduling system 180. In an example, the scheduling system 180 is a packaged functional hardware unit designed for use with other components/systems. In another example, the scheduling system 180 is a portion of a program code (e.g., software or firmware) executable by a processor or processing circuitry. In yet another example, the scheduling system 180 is a self-contained hardware and/or software component/system that interfaces with other components and/or systems. Although the scheduling system 180 is shown as being part of the controller 150, the scheduling system 180 may be separate from the controller 150.

The scheduling system 180 is operable to proactively erase a target metablock of the memory device 155 based, at least in part, on a sum of a size of write commands that are to be executed on a currently operating metablock (or memory block) of the memory device 155. In an example, the currently operating metablock is a metablock on which one or more received commands (e.g., commands received from the host device 105) are currently being executed. In an example, the currently operating metablock includes one or more memory blocks from one or more of the first memory die 165 and/or the second memory die 170. In another example, the target metablock includes one or more memory blocks of one or more memory dies of the first memory die 165 and/or the second memory die 170.

To determine whether to proactively erase a target metablock, the scheduling system 180 analyzes various received commands and determines which of the commands are write commands. The scheduling system 180 also determines a size of each write command and/or a sum of the size of the write commands. For example, if the scheduling system 180 identifies three write commands in that are to be executed on the currently operating metablock, and two of the write commands are associated with four kilobytes (KB) of data and the third write command is associated with eight KB of data, the sum of the size of the write commands is sixteen KB.

Based on determining the sum of the size of the write commands, the scheduling system 180 compares the sum of the size of the write commands to an available amount of space in the currently operating metablock. If the scheduling system 180 determines the sum of the size of the write commands does not exceed the available amount of space in the currently operating metablock, the scheduling system 180 takes no action. However, if the scheduling system 180 determines the sum of the size of the write commands exceeds the available amount of space in the currently operating metablock, the scheduling system 180 initiates an erase operation on the target metablock block. In an example, the erase operation is a full erase operation. In another example, the erase operation is a stepwise erase operation. In an example, the operations described herein are application to both types of erase operations.

In an example, the erase operation on the target metablock is initiated and/or completed prior to the currently operating metablock reaching capacity. For example, the erase operation on the target metablock is initiated and/or completed prior to the execution/completion of one or more write commands in the command queue that would cause the currently operating metablock to reach capacity and/or be closed.

In an example, memory dies associated with the currently operating metablock are different from the memory dies associated with the target metablock. For example, if the memory device 155 includes eight memory dies (e.g., Memory Die A, Memory Die B, Memory Die C, Memory Die D, Memory Die M, Memory Die N, Memory Die O and Memory Die P), the memory blocks of the currently operating metablock are associated with Memory Die A-Memory Die D and the memory dies associated with the target metablock are associated with Memory Die O-Memory Die P. As a result, the erase operations on the memory dies associated with the target metablock can occur in parallel with the write operations being executed on the currently operating metablock.

In other examples, one or more of the memory dies associated with the currently operating metablock are the same as one or more of the memory dies associated with the target metablock. In such an example, the erase operations occur concurrently with the write operations being executed on the currently operating metablock. For example, as write operations are being executed on the currently operating metablock, the memory dies would be free in between different write operations. As such, erase operations (e.g., stepwise erase operations) are initiated on the target metablock during the time in between the various write operations. In other example, the scheduling system 180 throttles one or more write commands on the currently operating metablock to help ensure the target metablock is ready to receive data when the currently operating metablock has reached capacity.

Information about which metablocks (e.g., the currently operating metablock and/or the target metablock) are associated with which memory dies is stored as metadata 175. In examples, the metadata 175 also includes garbage collection information, wear leveling information, a number of program/erase (P/E) cycles of a memory block and/or metablock, logical to physical mappings, and other information. In another example, the metadata 175 includes information regarding the sum of the size of received commands.

In an example, the commands that are to be executed on the currently operating metablock are received from the host device 105. In another example, the commands that are to be executed on the currently operating metablock are relocation operations associated with a garbage collection process. In yet another example, the commands that are to be executed on the currently operating metablock are part of a folding operation in which data from a first type of one or more memory blocks (e.g., SLC memory blocks) is folded into a second type of one or more memory blocks (e.g., MLC memory blocks).

In the examples described herein, and regardless from where the commands originate, a write command that is to be executed on the currently operating metablock is received and/or stored in a command queue. In an example, the command queue is maintained by the controller 150 and/or the scheduling system 180. The command queue receives and/or stores commands that are to be executed on the currently operating metablock. However, when the commands are in the command queue, the commands have yet to be executed.

Thus, in the examples described herein, the command queue contains or stores received/submitted commands. As a result of receiving and storing the commands, the scheduling system 180 has knowledge about upcoming commands that are to be executed on the currently operating metablock. For example, the scheduling system 180 has knowledge about the upcoming command types and the upcoming command sizes. However, proactively erasing one or more memory blocks for a target metablock (if necessary based on command parameters and currently operating metablock capacity) is performed prior to at least one of the commands in the command queue being executed.

In an example, the scheduling system 180 is part of firmware associated with the data storage device 110. In another example, the scheduling system 180 includes or is associated with a flash translation layer (FTL). In such an example, the FTL provides or determines output data size of the operations that are currently being executed on the currently operating metablock, determines the sum of the size of the write commands and/or determines whether the sum of the size of the write commands exceeds the amount of available space of the currently operating metablock.

In an example, the scheduling system 180 determines a sum of the size of the write commands for both random write commands and sequential write commands. The operations described herein may then be applied to each type of command individually or jointly. For example, if the scheduling system 180 determines that a currently operating metablock is a sequential metablock to which sequential data is routed, the scheduling system 180 determines the sum of the size of the write commands fitting a sequential condition for the currently operating metablock, verifies that the sum of sizes of the waiting commands exceed the current amount of free space, and also sends a proactive erase request to a target metablock based, at least in part, on a confidence level that the target metablock block will be used during the execution of sequential commands within a predetermined amount of time. The same logic is also contemplated for random writes.

In an example, the scheduling system 180 can also use the concepts described herein as it relates to garbage collection operations and/or relocation operations associated with garbage collection operations. For example, the scheduling system 180 can proactively erase a target destination metablock for writes associated with the garbage collection process when the scheduling system determines that the amount of available space in a current garbage collection destination metablock is less than a product of a garbage collection balancing ratio and an accumulated size of write commands received from the host device 105.

In an example, the garbage collection balancing ratio is an amount of garbage collection operations that are performed per host device 105 write. For example, if the ratio is one, then equal amount of garbage collection data is moved to the destination metablock for a given host write into another metablock.

In an example, a command in the command queue is a read-modified-write (RMW) command. When a RMW command is received and stored in the command queue, the write command will undergo a prior read operation, which could impact the amount of write bytes in the currently operating metablock. In such examples, the scheduling system 180 determines the number of extra sectors (RMW sectors) that would be written to the currently operating metablock and adds the number of sectors to the sum of the size of the received commands. This number is then compared to the amount of free space in the currently operating metablock to determine whether a proactive erase operation on a target metablock should be initiated. For example, if the command queue receives a one sector write command, the scheduling system 180 aligns that sector to the nearest 4 KB fragment (e.g., a fragment having eight sectors), and will use eight sectors as the command size in its calculation.

In another example, the scheduling system 180 can proactively erase memory blocks of a target metablock even after an error occurs. For example, if the controller 150 and/or the scheduling system 180 determines an error has occurred, the scheduling system 180 is operable to determine the lost physical space (size) due to the error and consider the lost size when performing the comparison between the sum of size of the received write commands and the available amount of space on the currently operating metablock. In another example, when an error is detected, the scheduling system 180 and/or the controller 150 will forgo the comparison, at least for a period of time.

In an example, the scheduling system 180 periodically checks (e.g., after N commands have been received) the command queue and/or the available amount of space on the currently operating metablock. In another example, the scheduling system 180 checks the command queue based, at least in part, on an operating state of the data storage device 110. For example, if the data storage device 110 is in a burst mode, a sustained mode, or an urgent mode, the scheduling system 180 may analyze the command queue and/or proactively erase target metablocks more (or less) frequently.

In yet another example, the scheduling system 180 checks or determines the sum of the size of the write commands in the command queue based, at least in part, on capacity information associated with the currently operating metablock and/or the number/type of commands in the command queue. For example, the scheduling system 180 will check the command queue at a first frequency when the currently operating metablock is at a first capacity (e.g., less than 90% full) and/or when the command queue has a first number of commands and will check the command queue at a second frequency when the currently operating metablock is at a second capacity (e.g., higher than 90% full) and/or when the command queue has a second number of commands.

In yet another example, a size of one or more commands in the command queue may not be readily detectable by the scheduling system 180. In such examples, the scheduling system 180 evaluates the write commands in the command queue using a prediction algorithm. In an example, the prediction algorithm predicts the size of the write commands based, at least in part, on previously received and/or executed write commands and/or on a current workload. For example, the scheduling system 180 determines, based on the history of received commands, an average size of the previously received and/or executed write commands. The average size is applied to the write command with the unknown size.

In another example, the scheduling system 180 applies the various operations described herein to double erase memory devices. For example, if a memory device requires double erase operations, the scheduling system proactively erases a target metablock in one of two ways (e.g., based on memory device characterization).

For example, the scheduling system 180 performs a first erase on a target metablock based, at least in part, on a comparison of free space in the currently operating metablock and on the sum of the size of the write commands and performs a second erase on the target metablock after the currently operating metablock is closed. As such, latency associated with first erase cycle is eliminated.

In another example, the scheduling system 180 performs both erase cycles, one after another, based, at least in part, on the amount of available space in the currently operating metablock and the sum of the size of the write commands, which eliminates the latencies associated with both the erase cycles. In such an example, a time delay between the two erase cycles, and the margins, is governed by design requirements.

The concepts described herein are also applicable to a memory device that implements a folding architecture. For example, the scheduling system 180 applies the operations described herein to SLC blocks used for host routing and the amount of available space in the currently operating metablock is based on the unwritten wordlines (and strings) in a particular memory block (or blocks). In a direct-write architecture, the scheduling system 180 applies the concept to MLC (any multi-level) blocks for directly routing host data and the free space is based on the unwritten wordlines (and strings) for corresponding multiple bits in a cell.

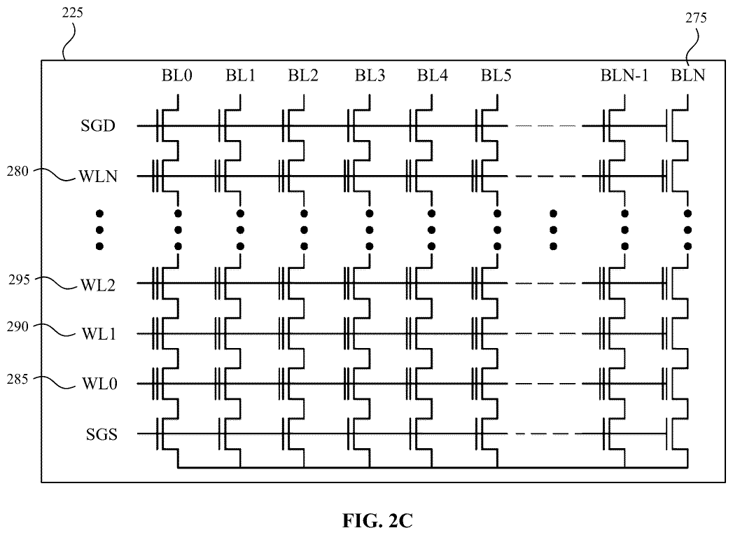

FIG. 3A illustrates a command queue 300 according to an example and FIG. 3B illustrates a currently operating metablock 360 according to an example. In an example, the command queue 300 is maintained and/or accessible by a scheduling system of a data storage device such as, for example, the scheduling system 180 of the data storage device 110 shown and described with respect to FIG. 1. The currently operating metablock 360 is a metablock of the data storage device on which one or more of the commands in the command queue 300 are currently being executed or will be executed.

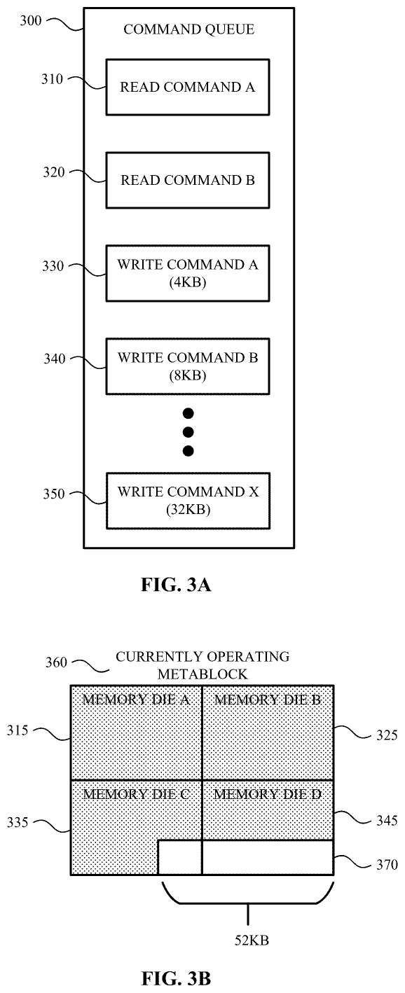

In the examples that follow, a single command queue 300 and a single currently operating metablock 360 (and a single target metablock 410 (FIG. 4B)) are shown and described. However, it is contemplated that a data storage device may have multiple command queues (or multiple portions or sections of a single command queue) that target multiple different currently operating metablocks and/or target metablocks. As such, a single scheduling system, or multiple scheduling systems, can simultaneously, or in series, track the capacity of various command queues and/or currently operating metablocks and/or initiate proactive erase operations on multiple target metablocks.

In an example, the command queue 300 includes a number of different types of commands and each command may be associated with a different size or amount of data. For example, the command queue 300 includes Read Command A 310, Read Command B 320, Write Command A 330 (having a size of 4 KB), Write Command B 340 (having a size of 8 KB) and Write Command X 350 (having a size of 32 KB). In an example, Write Command A 330 is a random write command while Write Command B 340 and Write Command X 350 are sequential write commands. Although a specific number of commands, types of commands and sizes of commands are shown and described, these are for example purposes only. The command queue 300 can have any number of different types, sizes and/or number of commands.

As previously explained, one or more of the commands in the command queue 300 are to be executed on the currently operating metablock 360. In an example, the currently operating metablock 360 includes memory blocks from four different memory dies-Memory Die A 315, Memory Die B 325, Memory Die C 335, and Memory Die D 345. In another example, the currently operating metablock 360 includes one or more memory blocks from the same memory dies.

In an example, the scheduling system accesses the command queue 300 and determines or identifies the write commands in the command queue 300. As part of this process, the scheduling system also determines a size of each write command and calculates a sum of the size of all of the write commands. As previously explained, command queue includes Write Command A 330 having a size of 4 KB, Write Command B 340 having a size of 8 KB and Write Command X 350 (having a size of 32 KB. Thus, the scheduling system determines the sum of the size of the write commands is 44 KB.

The scheduling system also determines capacity information associated with the currently operating metablock 360. In this example, the scheduling system determines that the currently operating metablock 360 has an available capacity 370 of 52 KB. The scheduling system compares the sum of the size of the write commands in the command queue 300 to the determined capacity information of the currently operating metablock 360 to determine whether a target metablock should be proactively erased. However, because the sum of the size of the write commands in the command queue 300 is 44 KB and the capacity of the currently operating metablock 360 is 52 KB, the scheduling system determines that no proactive erase action is to be taken.

FIG. 4A illustrates the command queue 300 of FIG. 3A in which another write command has been received according to an example and FIG. 4B illustrates how a target metablock 410 is proactively erased in response to a scheduling system determining a sum of a size of write commands in the command queue 300 of FIG. 4A exceeds a capacity of a currently operating metablock 360 according to an example. In an example, similarly number components function in the manner previously described. As such, a detailed explanation of the similarly numbered components has been omitted for clarity and brevity.

In this example, the newly received command is a write command-Write Command Y 400, which has a command size of 40 KB. Based, at least in part, on receiving Write Command Y 400, the scheduling system determines that the sum of the size of the write commands in the command queue 300 is 84 KB. The scheduling system also determines that the available capacity 370 in the currently operating metablock 360 is 52 KB. Because the sum of the size of the write commands in the command queue 300 is 84 KB and the available capacity 370 in the currently operating metablock 360 is 52 KB, the scheduling system proactively erases one or more memory blocks associated with a target metablock 410.

In an example, the erase operations on the memory blocks associated with the target metablock 410 are initiated and/or completed before the currently operating metablock 360 has reached capacity. For example, the scheduling system causes the memory blocks associated with the target metablock to be erased before Write Command Y 400 is executed.

In an example, Write Command A 330, Write Command B 340 and Write Command X 350 are executed in parallel with the erase operations that are performed on the target metablock 410. For example and as previously described, the scheduling system may select or identify target metablocks that are associated with memory dies that are different than the memory dies associated with the currently operating metablock 360. In this example, the currently operating metablock 360 is associated with Memory Die A 315, Memory Die B 325, Memory Die C 335, and Memory Die D 345 while the target metablock 410 is associated with Memory Die M 420, Memory Die N 430, Memory Die O 440, and Memory Die P 450. Because the currently operating metablock 360 is associated with a first set of memory dies and the target metablock is associated with a second set of memory dies, the write operations can be performed on the currently operating metablock 360 in parallel with the erase operations performed on the target metablock 410.

In another example, at least one memory die of the target metablock 410 is the same as at least one memory die of the currently operating metablock 360. For example, the target metablock 410 and the currently operating metablock 360 may each be associated with Memory Die A 315. In such an example, the erase operations that will be executed on Memory Die A 315 for the target metablock 410 will occur in a stepwise manner with respect to the write operations that are being executed on the currently operating metablock 360. For example, the erase operations on Memory Die A 315 for the target metablock 410 will occur in between write operations that are executed on Memory Die A 315 for the currently operating metablock 360.

In an example, the scheduling system schedules the erase operation on the target metablock to be completed at the same time, at substantially the same time or within a threshold amount of time, as the currently operating metablock reaches capacity and/or is closed. As such, write operations that are executing and/or that will be executed, are executed on the target metablock with little to no delay (e.g., the 5 ms or more delay previously discussed is reduced or eliminated).

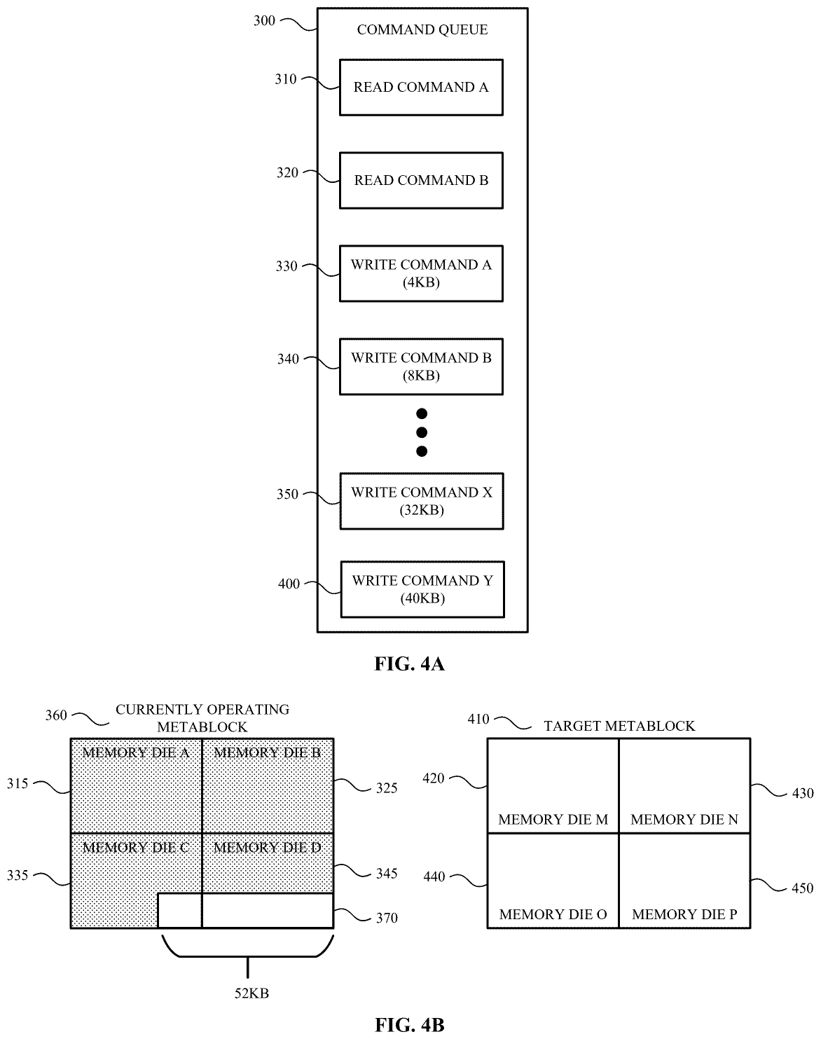

FIG. 5A illustrates the command queue 300 of FIG. 3A in which some commands have been executed and additional commands have been received according to an example. FIG. 5B illustrates how a target metablock 410 is proactively erased in response to a scheduling system determining a sum of a size of write commands in the command queue 300 of FIG. 5A exceeds a capacity of a currently operating metablock 360 according to an example. In an example, similarly number components function in the manner previously described. As such, a detailed explanation of the similarly numbered components has been omitted for clarity and brevity.

In this example, Read Command A 310, Read Command B 320 and Write Command A 330 have been executed on the currently operating metablock 360. As such, these commands have been removed from the command queue 300. Additionally, because the Write Command A had a size of 4 KB, the available capacity 370 of the currently operating metablock has been updated to 48 KB (from 52 KB).

In this example, another read command, Read Command X 510, has been received in the command queue 300. Likewise, another write command, Write Command Z 520 (having a size of 12 KB) is also received in the command queue 300.

Like the previous examples, the scheduling system determines a sum of the size of the commands in the command queue 300 and compares the sum of the size of the write commands to the available capacity 370 of the currently operating metablock 360. In this example, the sum of the size of the write commands in the command queue 300 is 52 KB. Because the sum of the size of the write commands is greater than the updated available capacity 370 of the currently operating metablock 360, the scheduling system proactively erases the target metablock 410 such as previously described.

In an example, the scheduling system determines, based on the number of commands in the command queue 300, the type of commands in the command queue 300 and/or the size of the commands in the command queue 300, a time at which the target metablock 410 will be accessed and/or written to. As such, the scheduling system will initiate the erase operations on the target metablock 410 in such a way that the target metablock 410 will be in the erased state for under a threshold or predetermined amount of time.

For example, if the scheduling system determines the command queue 300 includes N read commands and X write commands, but a majority of the read commands will be executed before one or more of the X write commands, the scheduling system will not initiate the erase operations on the target metablock 410 until M read commands have been executed (where M is less than, or equivalent to, N). In another example, the scheduling system determines an amount of time that is required for erasing the target metablock 410 and an amount of time it will take (e.g., based on the number and/or type of commands in the command queue 300) for the currently operating metablock 360 to reach capacity. In such an example, the scheduling system will initiate the erase operations on the target metablock 410 based, at least in part, on the determined timing. When the target metablock 410 is erased, various operations in the command queue 300 are executed on the target metablock.

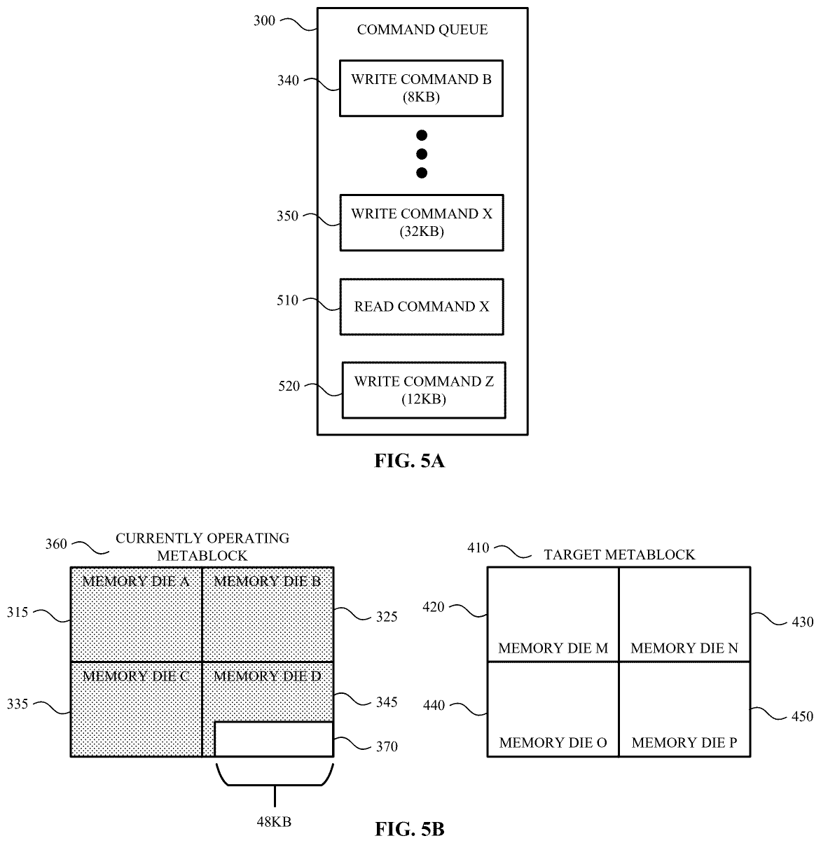

FIG. 6 illustrates a method 600 for proactively erasing memory blocks of a target metablock according to an example. In an example, the method 600 is performed by scheduling system of a data storage device such as, for example, the scheduling system 180 of the data storage device 110 shown and described with respect to FIG. 1.

In an example, the method 600 begins when the scheduling system analyzes (610) one or more commands in a command queue. In an example, the commands in the command queue are to be executed on a currently operating metablock of the data storage device. Although a currently operating metablock is specifically mentioned, the various operations and processes described herein may be executed on a single memory block, a single sub-block of a memory block, a metablock that is comprised of sub-blocks, multiple memory blocks and/or multiple sub-blocks.

In one example, the commands in the command queue are received from a host device. In another example, the commands are received as part of a relocation operation or a garbage collection operation. As such, the commands are in a firmware queue and/or a garbage collection queue.

In an example, the scheduling system analyzes the commands in the command queue periodically. In another example, the scheduling system analyses the commands in the command queue based on one or more trigger events. For example, the trigger events may be one or more of: the command queue reaching or exceeding a threshold number of commands; an amount of time since a previous analysis was initiated or completed; a number of commands that have been executed since a previous analysis was initiated or completed; a determined capacity of the currently operating metablock; an operating state (e.g., burst mode, sustained mode, urgent mode) of the data storage device and so on.

As part of the analysis, the scheduling system identifies which commands in the command queue are write commands. When the write commands are identified, the scheduling system calculates (620) a sum of the size of the write commands in the command queue. For example, if the command queue includes ten commands and five of the commands are write commands, the scheduling system determines an amount of data that will be written to a metablock (e.g., a size of each write command) when that particular write command is executed. The scheduling system also determines the total amount of data (e.g., the sum) that is to be written to the metablock should all of the write commands be executed.

The scheduling system also determines (630) an available capacity of a currently operating metablock. In an example, the currently operating metablock is a metablock on which commands in the command queue are currently being executed or on which one or more commands in the command queue will (at least partially) be executed.

Based, at least in part, on the scheduling system calculating the sum of the size of write commands in the command queue and on determining the available capacity of the currently operating metablock, the scheduling system determines (640) whether the available capacity of the currently operating metablock is greater than the sum of the size of the write commands in the command queue. If the scheduling system determines (640) the available capacity of the currently operating metablock is greater than the sum of the size of the write commands in the command queue, flow proceeds back to operation 610 and the method 600 is repeated.

However, if the scheduling system determines (640) the available capacity of the currently operating metablock is less than the sum of the size of the write commands in the command queue, the scheduling system identifies (650) a target metablock for a proactive erase operation. In an example, the scheduling system identifies the target metablock based, at least in part, on memory dies that are associated with the target metablock and/or a set of memory dies that are associated with the currently operating metablock.

For example, if the currently operating metablock is associated with a first set of memory dies (e.g., Memory Die A, Memory Die B, Memory Die C and Memory Die D), the scheduling system will identify a target metablock that is associated with a second set of memory dies (e.g., Memory Die M, Memory Die N, Memory Die O and Memory Die P). In another example, a target metablock is identified based on other characteristics of the target metablock. For example, the scheduling system identifies a target metablock based, at least in part, on a number of P/E cycles associated with the target metablock, a location (e.g., die and/or plane) of the one or more physical memory blocks that comprise the target metablock and so on.

When the target metablock has been identified, the scheduling system initiates (660) an erase operation on the target metablock. In an example, the erase operation is initiated and/or completed in parallel with one or more operations that are being executed on the currently operating metablock. In another example, the erase operation is initiated and/or completed on the target metablock prior to the currently operating metablock reaching capacity and/or being closed.

When the currently operating metablock has reached capacity and the target metablock is erased, the scheduling system enables commands in the command queue to be executed (670) on the target metablock. The method 600 is then repeated on the target metablock (now referred to as the currently operating metablock).

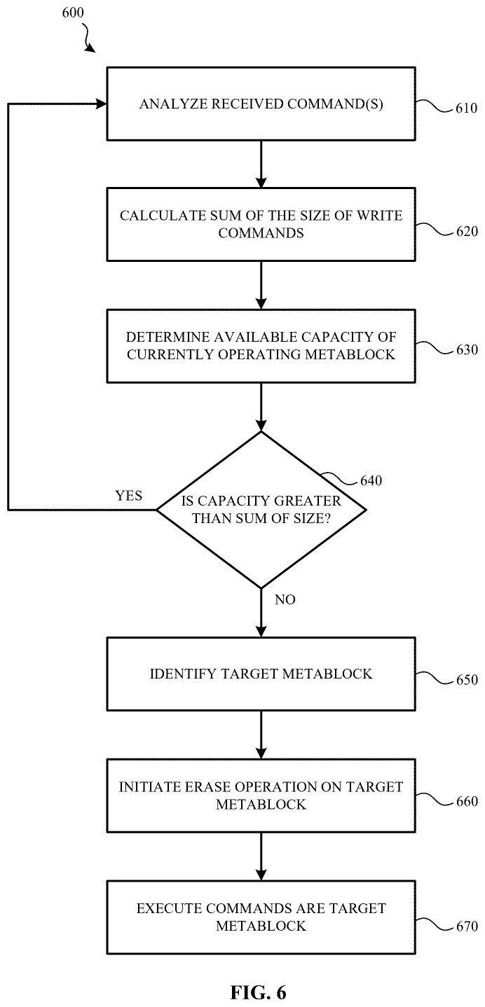

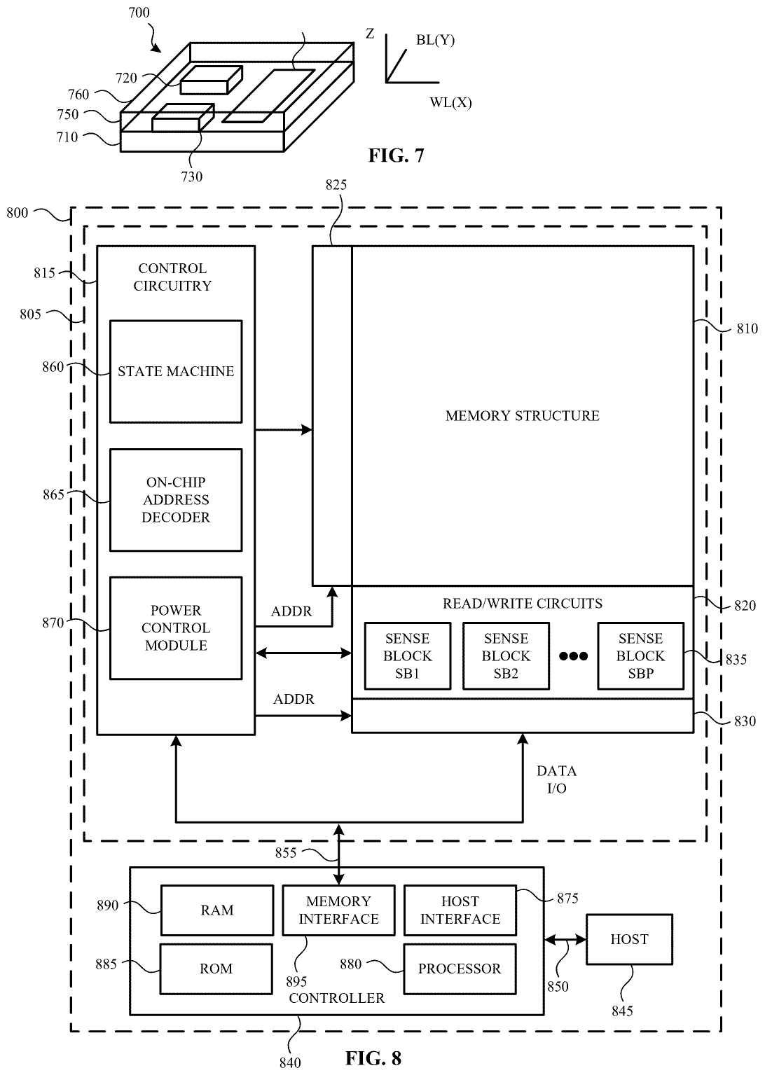

FIG. 7-FIG. 8 describe example storage devices that may be used with or otherwise implement the various features described herein. For example, the storage devices shown and described with respect to FIG. 7-FIG. 8 may include various systems and components that are similar to the systems and components shown and described with respect to FIG. 1. For example, the controller 822 shown and described with respect to FIG. 8 may be similar to the controller 150 of FIG. 1. Likewise, the memory dies 808 may be similar to the first memory die 165 and/or the second memory die 170 of FIG. 1.

FIG. 7 is a perspective view of a storage device 700 that includes three-dimensional (3D) stacked non-volatile memory according to an example. In this example, the storage device 700 includes a substrate 710. Blocks of memory cells are included on or above the substrate 710. The blocks may include a first block 720 (BLK0) and a second block 730 (BLK1). Each block may be formed of memory cells (e.g., non-volatile memory elements). The substrate 710 may also include a peripheral area 740 having support circuits that are used by the first block 720 and the second block 730. The peripheral area 740 may be located beneath the first block 720 and the second block 730. In another example, the peripheral area may be included on a different substrate or die.

The substrate 710 may also carry circuits under the blocks, along with one or more lower metal layers which are patterned in conductive paths to carry signals from the circuits. The blocks may be formed in an intermediate region 750 of the storage device 700. The storage device may also include an upper region 760. The upper region 760 may include one or more upper metal layers that are patterned in conductive paths to carry signals from the circuits. Each block of memory cells may include a stacked area of memory cells. In an example, alternating levels of the stack represent wordlines. While two blocks are depicted, additional blocks may be used and extend in the x-direction and/or the y-direction.

In an example, a length of a plane of the substrate 710 in the x-direction represents a direction in which signal paths for wordlines or control gate lines extend (e.g., a wordline or drain-end select gate (SGD) line direction) and the width of the plane of the substrate 710 in the y-direction represents a direction in which signal paths for bit lines extend (e.g., a bit line direction). The z-direction represents a height of the storage device 700.

FIG. 8 is a functional block diagram of a storage device 800 according to an example. In an example, the storage device 800 may be the 3D stacked non-volatile storage device 700 shown and described with respect to FIG. 7. The components depicted in FIG. 8 may be electrical circuits. In an example, the storage device 800 includes one or more memory dies 805. Each memory die 805 includes a three-dimensional memory structure 810 of memory cells (e.g., a 3D array of memory cells), control circuitry 815, and read/write circuits 820. In another example, a two-dimensional array of memory cells may be used. The memory structure 810 is addressable by wordlines using a first decoder 825 (e.g., a row decoder) and by bit lines using a second decoder 830 (e.g., a column decoder). The read/write circuits 820 may also include multiple sense blocks 835 including SB1, SB2, . . . , SBp (e.g., sensing circuitry) which allow pages of the memory cells to be read or programmed in parallel. The sense blocks 835 may include bit line drivers.

In an example, a controller 840 is included in the same storage device 800 as the one or more memory dies 805. In another example, the controller 840 is formed on a die that is bonded to a memory die 805, in which case each memory die 805 may have its own controller 840. In yet another example, a controller die controls all of the memory dies 805.

Commands and data may be transferred between a host 845 and the controller 840 using a data bus 850. Commands and data may also be transferred between the controller 840 and one or more of the memory dies 805 by way of lines 855. In one example, the memory die 805 includes a set of input and/or output (I/O) pins that connect to lines 855.

The memory structure 810 may also include one or more arrays of memory cells. The memory cells may be arranged in a three-dimensional array or a two-dimensional array. The memory structure 810 may include any type of non-volatile memory that is formed on one or more physical levels of arrays of memory cells having an active area disposed above a silicon substrate. The memory structure 810 may be in a non-volatile memory device having circuitry associated with the operation of the memory cells, whether the associated circuitry is above or within the substrate.

The control circuitry 815 works in conjunction with the read/write circuits 820 to perform memory operations (e.g., erase, program, read, and others) on the memory structure 810. The control circuitry 815 may include registers, ROM fuses, and other devices for storing default values such as base voltages and other parameters.

The control circuitry 815 may also include a state machine 860, an on-chip address decoder 865, and a power control module 870. The state machine 860 may provide chip-level control of various memory operations. The state machine 860 may be programmable by software. In another example, the state machine 860 does not use software and is completely implemented in hardware (e.g., electrical circuits).

The on-chip address decoder 865 may provide an address interface between addresses used by host 845 and/or the controller 840 to a hardware address used by the first decoder 825 and the second decoder 830.

The power control module 870 may control power and voltages that are supplied to the wordlines and bit lines during memory operations. The power control module 870 may include drivers for wordline layers in a 3D configuration, select transistors (e.g., SGS and SGD transistors) and source lines. The power control module 870 may include one or more charge pumps for creating voltages.

The control circuitry 815, the state machine 860, the on-chip address decoder 865, the first decoder 825, the second decoder 830, the power control module 870, the sense blocks 835, the read/write circuits 820, and/or the controller 840 may be considered one or more control circuits and/or a managing circuit that perform some or all of the operations described herein.

In an example, the controller 840, is an electrical circuit that may be on-chip or off-chip. Additionally, the controller 840 may include one or more processors 880, ROM 885, RAM 890, memory interface 895, and host interface 875, all of which may be interconnected. In an example, the one or more processors 880 is one example of a control circuit. Other examples can use state machines or other custom circuits designed to perform one or more functions. Devices such as ROM 885 and RAM 890 may include code such as a set of instructions. One or more of the processors 880 may be operable to execute the set of instructions to provide some or all of the functionality described herein.

Alternatively or additionally, one or more of the processors 880 may access code from a memory device in the memory structure 810, such as a reserved area of memory cells connected to one or more wordlines. The memory interface 895, in communication with ROM 885, RAM 890, and one or more of the processors 880, may be an electrical circuit that provides an electrical interface between the controller 840 and the memory die 805. For example, the memory interface 895 may change the format or timing of signals, provide a buffer, isolate from surges, latch I/O, and so forth.

The one or more processors 880 may issue commands to control circuitry 815, or any other component of memory die 805, using the memory interface 895. The host interface 875, in communication with the ROM 885, the RAM 890, and the one or more processors 880, may be an electrical circuit that provides an electrical interface between the controller 840 and the host 845. For example, the host interface 875 may change the format or timing of signals, provide a buffer, isolate from surges, latch I/O, and so on. Commands and data from the host 845 are received by the controller 840 by way of the host interface 875. Data sent to the host 845 may be transmitted using the data bus 850.

Multiple memory elements in the memory structure 810 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a RAM configuration.

Examples of the present disclosure describe a method, comprising: identifying one or more write commands that are to be executed on a currently operating metablock of a data storage device; determining a size associated with each of the one or more write commands; determining an amount of available space in the currently operating metablock; comparing the amount of available space in the currently operating metablock with a sum of the determined size associated with each of the one or more write commands; and initiating an erase operation on a target metablock based, at least in part, on determining the sum of the determined size associated with each of the one or more write commands is greater than the amount of available space in the currently operating metablock, wherein the erase operation is initiated prior to the currently operating metablock reaching capacity. In an example, the method also includes writing data associated with the one or more write commands to the target metablock when the currently operating metablock reaches capacity. In an example, the currently operating metablock is associated with a first set of memory dies and the target metablock is associated with a second set of memory dies that are different than the first set of memory dies. In an example, the erase operation is a stepwise erase operation. In an example, the target metablock is a destination metablock associated with a relocation operation of a garbage collection process. In an example, the one or more write commands are in a command queue. In an example, at least a portion of the erase operation is executed in parallel with a write operation that is executed on the currently operating metablock. In an example, the currently operating metablock is comprised of one or more sub-blocks of a physical memory block.

Examples also describe a data storage device, comprising: a controller; and a scheduling system associated with the controller and operable to: analyze one or more received commands; identify which of the one or more commands are write commands; determine a sum of a size of the write commands in the command queue; compare an amount of available space in a currently operating metablock with the sum of the size of the write commands; and initiate an erase operation on a target metablock based, at least in part, on a determination that the sum of the size of the write commands exceeds the amount of available space in the currently operating metablock, wherein the erase operation is initiated prior to the currently operating metablock reaching capacity. In an example, the scheduling system is further operable to cause data associated with the one or more write commands to be written to the target metablock when the currently operating metablock reaches capacity. In an example, each memory block of the currently operating metablock is associated with a first set of memory dies and wherein each memory block of the target metablock is associated with a second set of memory dies that are different than the first set of memory dies. In an example, the one or more commands are associated with a relocation operation of a garbage collection process. In an example, the scheduling system is further operable to: determine a garbage collection balancing ratio; and execute write commands on the target metablock based, at least in part, on the garbage collection balancing ratio. In an example, the one or more commands are received from a host device. In an example, at least a portion of the erase operation on the target metablock is executed in parallel with a write operation that is executed on the currently operating metablock.

Examples also describe a data storage device, comprising: means for identifying one or more write commands that are to be executed on a currently operating metablock of a data storage device; means for determining a size associated with each of the one or more write commands; means for determining an amount of available space in the currently operating metablock; means for comparing the amount of available space in the currently operating metablock with a sum of the determined size associated with each of the one or more write commands; and means initiating an erase operation on a target metablock, wherein the erase operation is initiated based, at least in part, on a determination that the sum of the determined size associated with each of the one or more write commands is greater than the amount of available space in the currently operating metablock, wherein the erase operation is initiated while one or more write commands are being executed on the currently operating metablock. In an example, each memory block of the currently operating metablock is associated with a first set of memory dies and wherein each memory block of the target metablock is associated with a second set of memory dies that are different than the first set of memory dies. In an example, the target metablock is associated with a relocation operation of a garbage collection process. In an example, at least a portion of the erase operation on the target metablock is executed in parallel with a write operation that is executed on the currently operating metablock. In an example, the currently operating metablock is comprised of one or more sub-blocks of a physical memory block.

One of ordinary skill in the art will recognize that the technology described herein is not limited to a single specific memory structure, but covers many relevant memory structures within the spirit and scope of the technology as described herein and as understood by one of ordinary skill in the art.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method, comprising:
identifying one or more write commands that are to be executed on a currently operating metablock of a data storage device;
determining a size associated with each of the one or more write commands;
determining an amount of available space in the currently operating metablock;
comparing the amount of available space in the currently operating metablock with a sum of the determined size associated with each of the one or more write commands; and
initiating an erase operation on a target metablock based, at least in part, on determining the sum of the determined size associated with each of the one or more write commands is greater than the amount of available space in the currently operating metablock, wherein the erase operation is initiated prior to the currently operating metablock reaching capacity.

2. The method of claim 1, further comprising writing data associated with the one or more write commands to the target metablock when the currently operating metablock reaches capacity.

3. The method of claim 1, wherein the currently operating metablock is associated with a first set of memory dies and the target metablock is associated with a second set of memory dies that are different than the first set of memory dies.

4. The method of claim 1, wherein the erase operation is a stepwise erase operation.

5. The method of claim 1, wherein the target metablock is a destination metablock associated with a relocation operation of a garbage collection process.

6. The method of claim 1, wherein the one or more write commands are in a command queue.

7. The method of claim 1, wherein at least a portion of the erase operation is executed in parallel with a write operation that is executed on the currently operating metablock.

8. The method of claim 1, wherein the currently operating metablock is comprised of one or more sub-blocks of a physical memory block.

9. A data storage device, comprising:
a controller; and
a scheduling system associated with the controller and operable to:
analyze one or more received commands;
identify which of the one or more commands are write commands;
determine a sum of a size of the write commands in the command queue;
compare an amount of available space in a currently operating metablock with the sum of the size of the write commands; and
initiate an erase operation on a target metablock based, at least in part, on a determination that the sum of the size of the write commands exceeds the amount of available space in the currently operating metablock, wherein the erase operation is initiated prior to the currently operating metablock reaching capacity.

10. The data storage device of claim 9, wherein the scheduling system is further operable to cause data associated with the one or more write commands to be written to the target metablock when the currently operating metablock reaches capacity.

11. The data storage device of claim 9, wherein each memory block of the currently operating metablock is associated with a first set of memory dies and wherein each memory block of the target metablock is associated with a second set of memory dies that are different than the first set of memory dies.

12. The data storage device of claim 9, wherein the one or more commands are associated with a relocation operation of a garbage collection process.

13. The data storage device of claim 12, wherein the scheduling system is further operable to:
determine a garbage collection balancing ratio; and
execute write commands on the target metablock based, at least in part, on the garbage collection balancing ratio.

14. The data storage device of claim 9, wherein the one or more commands are received from a host device.

15. The data storage device of claim 9, wherein at least a portion of the erase operation on the target metablock is executed in parallel with a write operation that is executed on the currently operating metablock.

16. A data storage device, comprising:
means for identifying one or more write commands that are to be executed on a currently operating metablock of a data storage device;
means for determining a size associated with each of the one or more write commands;
means for determining an amount of available space in the currently operating metablock;
means for comparing the amount of available space in the currently operating metablock with a sum of the determined size associated with each of the one or more write commands; and
means initiating an erase operation on a target metablock, wherein the erase operation is initiated based, at least in part, on a determination that the sum of the determined size associated with each of the one or more write commands is greater than the amount of available space in the currently operating metablock, wherein the erase operation is initiated while one or more write commands are being executed on the currently operating metablock.

17. The data storage device of claim 16, wherein each memory block of the currently operating metablock is associated with a first set of memory dies and wherein each memory block of the target metablock is associated with a second set of memory dies that are different than the first set of memory dies.

18. The data storage device of claim 16, wherein the target metablock is associated with a relocation operation of a garbage collection process.

19. The data storage device of claim 16, wherein at least a portion of the erase operation on the target metablock is executed in parallel with a write operation that is executed on the currently operating metablock.

20. The data storage device of claim 16, wherein the currently operating metablock is comprised of one or more sub-blocks of a physical memory block.
